(19) United States
(12) Patent Application Publication
(10) Pub. No.: US 2025/0128666 A1
(43) Pub. Date: Apr. 24, 2025

(54) CHAIR COMPRISING A LOW FREQUENCY SPEAKER

(71) Applicant: Harman Becker Automotive Systems GmbH, Karlsbad (DE)

(72) Inventor: Daniel BRACHT, Karlsruhe (DE)

(73) Assignee: Harman Becker Automotive Systems GmbH, Karlsbad (DE)

(21) Appl. No.: 18/921,814

(22) Filed: Oct. 21, 2024

(30) Foreign Application Priority Data
Oct. 19, 2023 (DE) 10 2023 128 779.6

(51) Int. Cl. B60R 11/02; B60R 11/00; H04R 1/28; H04R 5/02

(52) U.S. Cl. CPC B60R 11/0217; H04R 1/2807; H04R 5/023; B60R 2011/0015

(57) ABSTRACT

A chair includes a seating area and a backrest, wherein the seating area is arranged at a lower end of the backrest, a low frequency speaker configured to emit sound at frequencies of between 20 Hz and 200 Hz, and a coupling mechanism, wherein the coupling mechanism is configured to change between at least two different states, wherein, in a first state, the low frequency speaker is coupled to the chair via at least one acoustical path such that vibrations are transmitted from the low frequency speaker to the chair via each of the at least one acoustical path, wherein the vibrations can be perceived as tactile feedback by a user seated on the chair, and, in a second state, each of the at least one acoustical path is interrupted such that no or almost no vibrations are transmitted from the low frequency speaker to the chair.

### CROSS-REFERENCE TO RELATED APPLICATIONS

This application claims priority to DE application Ser. No. 102023128779.6 filed Oct. 19, 2023, the disclosure of which is hereby incorporated in its entirety by reference herein.

### TECHNICAL FIELD

The disclosure relates to a chair comprising a low frequency speaker.

### BACKGROUND

Integration of speakers in a listening environment, for example, in a vehicle may be challenging. When integrating a speaker into a listening environment, many different aspects and constraints have to be considered. During the use of the speaker, the speaker may cause other elements to vibrate, thereby generating unwanted noise that adversely affect the listening experience of persons that are present in the listening environment. Even further, the acoustic performance of the speaker may suffer if a speaker is positioned in an unfavorable position. Loudspeakers may further be used to provide structure-borne sound to a user which, however, may be perceived as unpleasant by some users, especially if it is not well tuned.

There is a need for a chair comprising a low frequency speaker that is easily integrable and provides a satisfying listening experience.

### SUMMARY

A chair includes a seating area and a backrest, wherein the seating area is arranged at a lower end of the backrest, a low frequency speaker configured to emit sound at frequencies of between 20 Hz and 200 Hz, and a coupling mechanism, wherein the coupling mechanism is configured to change between at least two different states, wherein, in a first state, the low frequency speaker is coupled to the chair via at least one acoustical path such that vibrations are transmitted from the low frequency speaker to the chair via each of the at least one acoustical path, wherein the vibrations can be perceived as tactile feedback by a user seated on the chair, and, in a second state, each of the at least one acoustical path is interrupted such that no or almost no vibrations are transmitted from the low frequency speaker to the chair that cannot be perceived as tactile feedback by a user seated on the chair.

Other systems, features and advantages of the disclosure will be or will become apparent to one with skill in the art upon examination of the following detailed description and figures. It is intended that all such additional systems, methods, features and advantages included within this description, be within the scope of the invention and be protected by the following claims.

### BRIEF DESCRIPTION OF THE DRAWINGS

The arrangements may be better understood with reference to the following description and drawings. The components in the figures are not necessarily to scale, emphasis instead being placed upon illustrating the principles of the invention. Moreover, in the figures, like referenced numerals designate corresponding parts throughout the different views.

FIG. 1 schematically illustrates a three-dimensional view of a chair and a low frequency speaker.

FIG. 2 schematically illustrates a top view of a vehicle according to embodiments of the disclosure.

FIG. 3, including FIGS. 3A and 3B, schematically illustrates a cross-sectional view of a chair and a low frequency speaker according to embodiments of the disclosure.

FIG. 4 schematically illustrates a three-dimensional view of a low frequency speaker coupled to a chair.

FIG. 5, including FIGS. 5A and 5B, schematically illustrates a front views of a low frequency speaker that can be coupled to (FIG. 5A) or decoupled from (FIG. 5B) a chair.

FIG. 6, including FIGS. 6A to 6C, schematically illustrates side views of a low frequency speaker coupled to a chair.

FIG. 7, including FIGS. 7A to 7C, schematically illustrates side views of a low frequency speaker decoupled from a chair.

FIG. 8 schematically illustrates a low frequency speaker mounted to a frame of a chair.

FIG. 9 including FIGS. 9A and 9B, schematically illustrates three-dimensional views of a low frequency speaker coupled to (FIG. 9A) and decoupled from (FIG. 9B) a chair.

FIG. 10, including FIGS. 10A and 10B, schematically illustrates a coupling device according to embodiments of the disclosure for coupling a low frequency speaker to (FIG. 10A) or decoupling a low frequency speaker from (FIG. 10B) a chair.

### DETAILED DESCRIPTION

A loudspeaker, when coupled to a chair, provides air-borne sound which is audible for users in the vicinity of the loudspeaker. During the use of the loudspeaker, the loudspeaker vibrates and vibrations of the loudspeaker can be transferred via components of the chair such that vibrations transferred via the components can be perceived as tactile feedback by a user seated on the chair. While some people enjoy receiving (strong) tactile feedback, others prefer a listening experience without or with a comparably gentle tactile feedback. Therefore, according to embodiments of the disclosure, a loudspeaker, in a first state, may be coupled to a chair such that chair provides tactile feedback for a user seated on the chair. In a second state, the loudspeaker may be decoupled from the chair in order to not provide tactile feedback.

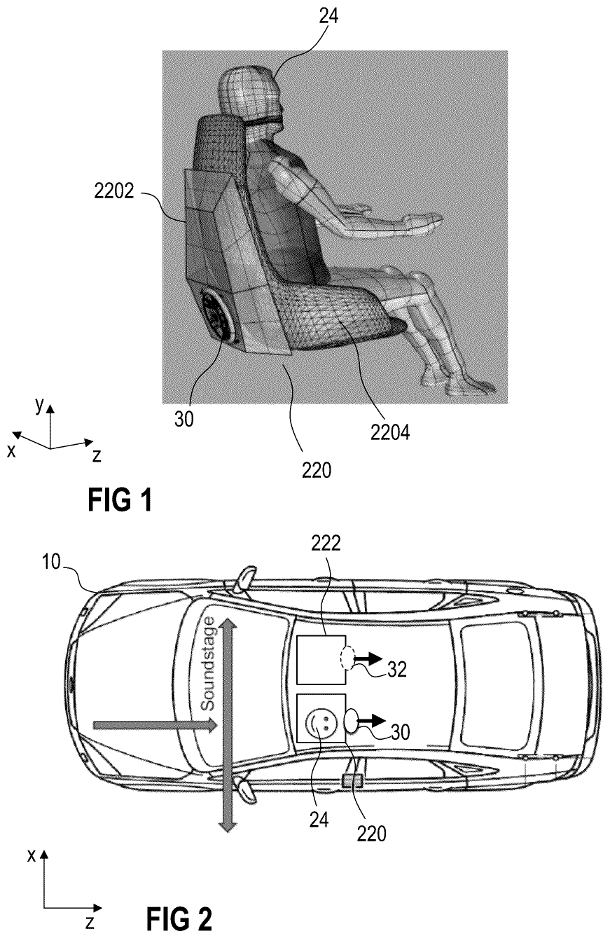

FIG. 1 schematically illustrates a chair 220 comprising a seating area 2204 and a backrest 2202. The seating area 2204 is arranged at a lower end of the backrest 2202. The lower end of a backrest 2202 generally is an end facing towards a ground surface (i.e. towards a ground surface the chair is arranged on). The chair 220 further comprises a low frequency speaker 30 configured to emit sound at frequencies of between 20 Hz and 200 Hz. The low frequency speaker 30 in the example illustrated in FIG. 1 is arranged in the backrest 2202, in particular on a backside of the backrest 2202 that faces away from the seating area 2204, and is therefore configured to emit sound (main direction of sound propagation) mainly in a direction facing away from the seating area 2204. That is, the low frequency speaker 30 (e.g., a sound radiating surface of the low frequency speaker 30) is directed towards one or more back seats arranged behind the respective chair 220. Positioning a low frequency speaker 30 in a backrest 2202 of a chair 220 such that it is directed away from the seating area 2204 of the chair 220 it is mounted in usually results in an optimized low frequency output (SPL), bandwidth and localization, for example. It is further possible to optimize the vibration (tactile feedback) of the low frequency speaker 30 in this position, for example, by way of (customized) damped mounting or a balanced woofer configuration (described in more detail below). Arranging the low frequency speaker 30 in the backrest 2202 of a chair 220, however, is only an example. Generally, the low frequency speaker 30 can be arranged in or attached to any other position on the chair 220. According to other examples, the low frequency speaker 30 is arranged in the seating area 2204 or in a headrest of the chair 220 instead.

The low frequency speaker 30 may be mechanically coupled to the chair 220 such that occupant user 24 seated on the chair 220 perceives vibrations generated by the low frequency speaker 30. This effect is also used, for example, in cinemas to enhance the perception of the sound (so-called shaker effect), and may also be referred to as structure-borne sound. An occupant 24 seated on the chair 220 may fully immerse in the sound (bass) generated by the low frequency speaker 30 such that the sound experience may be enhanced. Some people, however, generally perceive such tactile feedback as unpleasant. Other people may like to perceive tactile feedback only sometimes but not constantly. Even further, some people prefer strong tactile feedback, while others prefer a comparably gentle tactile feedback. Therefore, according to embodiments of the disclosure, the speaker 30, in a first state, may be coupled to the chair 220 such that speaker 30 and the chair 220 provide tactile feedback for a user seated on the chair 220. In a second state, the speaker 30 may be decoupled from the chair 220 in order to not provide tactile feedback. It is generally possible that in a third or any further states, the speaker 30 is only partly decoupled from the chair 220 to provide only a comparably mild tactile feedback, as compared to the first state.

For example, the chair 220 can be a car seat a driver's seat or a front passenger seat. This is schematically illustrated in FIG. 2. In particular, FIG. 2 schematically illustrates a top view of a vehicle 10. The vehicle 10 comprises a chair (car seat) 220 (e.g., a driver's seat). A low frequency speaker 30 is arranged in the backrest of the car seat 220. The low frequency speaker 30 is configured to emit sound at frequencies of between 20 Hz and 200 Hz. The low frequency speaker 30 is arranged at a backside of the car seat 220. That is, a sound radiating surface of the low frequency speaker 30 may be directed towards the back of the vehicle 10. In other words, a main direction of sound propagation may be directed towards the rear of the vehicle 10 (indicated by way of an arrow in FIG. 1). Low frequency sound waves (air-borne sound), however, generally propagate in all directions (spherical wave). Arranging a low frequency speaker 30 in this position in a car seat 220, 222 may result in a very pleasant listening experience of users seated on the car seats 220, 222. However, as has been described above, the low frequency speaker 30 can be arranged in any other position on or in the car seat 220, 222 instead. According to other examples, the chair 220 is a gaming chair or a chair in a cinema. That is, the chair 220 may generally be any kind of chair and may be arranged in any kind of listening environment.

According to one example, tactile feedback is provided to a user 24 seated on the chair 220 via a first acoustical path and via a second acoustical path in the first state. In the second state, both the first acoustical path and the second acoustical path are interrupted such that no tactile feedback is provided. In a third state (intermediate state), for example, tactile feedback is provided either via the first acoustical path or via the second acoustical path, but not via both. That is, in the third state, a comparably mild tactile feedback may be provided. Different examples of acoustical paths as well as different ways of interrupting acoustical paths will be exemplarily described in the following. Generally, an acoustical path, however, can be formed and interrupted in any suitable way. By providing or interrupting one or more acoustical paths, an individually satisfying listening experience can be provided for a user 24 seated on the chair 220.

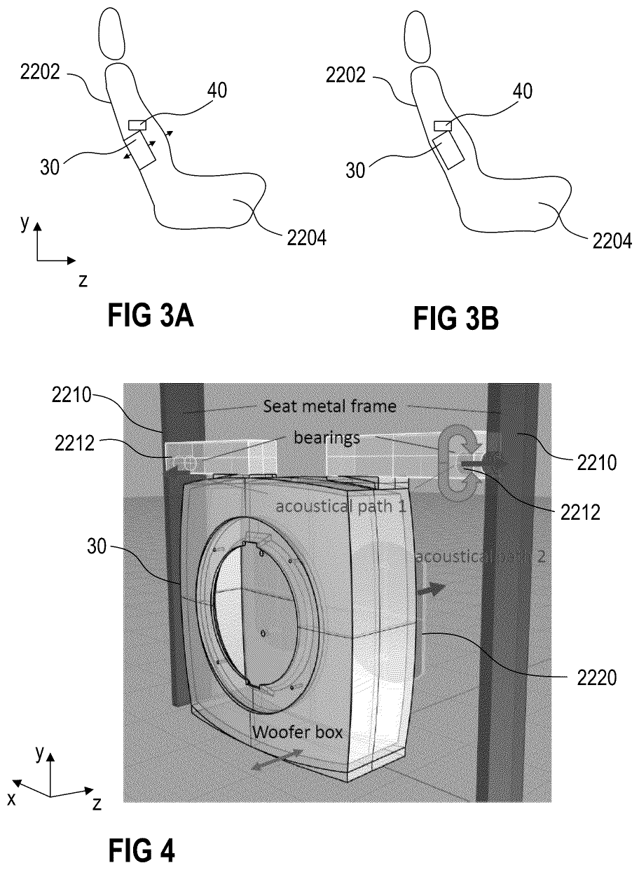

Now referring to FIG. 3, a chair 220 comprises a seating area 2204 and a backrest 2202, wherein the seating area 2204 is arranged at a lower end of the backrest 2202. A low frequency speaker 30 is arranged in the chair 220 and is configured to emit sound at frequencies of between 20 Hz and 200 Hz. The chair 220 further comprises a coupling mechanism 40 configured to change (e.g., switch or fade) between at least two different states, wherein, in a first state (FIG. 3A), the low frequency speaker 30 is coupled to the chair 220 via at least one acoustical path such that vibrations are transmitted from the low frequency speaker 30 to the chair 220 via each of the at least one acoustical path, wherein the vibrations can be perceived as tactile feedback by occupant user seated on the chair 220 (tactile feedback indicated by way of arrows), and, in a second state (FIG. 3B), each of the at least one acoustical path is interrupted such that no or almost no vibrations are transmitted from the low frequency speaker 30 to the chair 220 that cannot be perceived as tactile feedback by occupant user seated on the chair 220.

When the low frequency speaker 30 is coupled to the chair 220 and vibrations are transmitted from the low frequency speaker 30 to the chair 220 (i.e. the backrest 2202 and/or the seating area 2204), well balanced structure-borne sound is provided to an occupant seated on the chair 220 in a controlled way. A chair 220 may comprise a frame 2210, for example, a metal frame, which is covered by foam, cushion or upholstery. The frame 2210 and upholstery generally define the seating area 2204 and the backrest 2202 of the chair 220. The upholstery can be further covered by a layer of fabric, for example. For example, if the chair 220 is a car seat, different components such as, belt receptables, reclining mechanism, etc. may be mounted to the frame 2210.

As is exemplarily illustrated in FIG. 4, the speaker 30 may be mounted to the frame 2210 of the chair 220 by way of a bearing 2212. The frame 2210 may comprise backrest side members, for example, that are arranged along the sides (left and right) of the backrest 2202. For example, the speaker 30 may be mounted to such backrest side members via the bearing 2212, for example. A speaker 30 mounted to a frame 2210 of a chair 220 via a bearing 2212 is further schematically illustrated in FIG. 8. FIG. 8 schematically illustrates a “naked” frame of a chair with a speaker 30 mounted thereto. Any cushions or upholstery are omitted in FIG. 8 for improved clearness. Instead of to the backrest side members, the speaker 30 could be mounted to any other parts of the frame 2210. For example, the speaker 30 can also be mounted to parts of the frame 2210 defining the seating area 2204.

In the first state, the bearing 2212 provides a first acoustical path between the low frequency speaker 30 and the chair 220. Via this first acoustical path, vibrations of the low frequency speaker 30 are transmitted to the frame 2210. A user seated on the chair 220 perceives such vibrations as structure-borne sound (tactile feedback). The structure-borne sound that is coupled into the chair via the generally rigid (metal) frame 2210 gains comparably high bass frequencies (e.g., >50 Hz, or >100 Hz) and adds control to the bass that is subjectively perceived by the occupant.

The structure-borne sound transmitted to the chair 220 via the bearing 2212 and the frame 2210 alone, however, may be perceived as unpleasant by occupant user seated on the chair 220. For this reason, a second acoustic path may be provided for the structure-borne sound. In particular, at least a backside of the low frequency speaker 30 may directly or indirectly adjoin the upholstery of the chair 220. The backside of the low frequency speaker 30 is a side which faces towards an inside of the chair 220. That is, when the low frequency speaker 30 vibrates during its use, the vibrations may be transmitted to the frame 2210 of the chair 220 via the bearing 2212, and further directly from the low frequency speaker 30 to the upholstery. While the frame 2210 generally is a rigid component, the upholstery consists of or comprises foam or other comparably soft materials. Therefore, well noticeable low end (e.g., <50 Hz, or <40 Hz) structure-borne sound may be provided via the second acoustical path. Providing structure-borne sound solely via the second acoustical path may feel uncontrolled, powerless, or “flattery” for occupant user seated on the chair 220. Combining a first coupling impedance of a first acoustical path and a second coupling impedance of a second acoustical path may result in a very pleasant experience for a user seated on the chair 220. By balancing the first coupling impedance of the first acoustical path and the second coupling impedance of the second acoustical path in a suitable way, the tactile feedback (structure-borne sound) may be tuned in a highly pleasant way. The low end (e.g., <50 Hz) as well as the higher bass range (e.g. >50 Hz, or >100 Hz) are well balanced and bass control is optimized which is perceived as very pleasant by occupant user seated on the chair 220. Combining the first acoustical path and the second acoustical path described above, however, is only one example. It is also possible that in the first state either only the first acoustical path or only the second acoustical path is provided. Additionally or alternatively, other acoustical paths may be provided. Acoustical paths can be provided from the low frequency speaker 30 to areas of the backrest 2202, as described above, and/or to any other areas of the chair 220. For example, tactile feedback may be clearly perceived in the seating area 2204 (acoustical path provided from speaker 30 to elements of the seating area 2204).

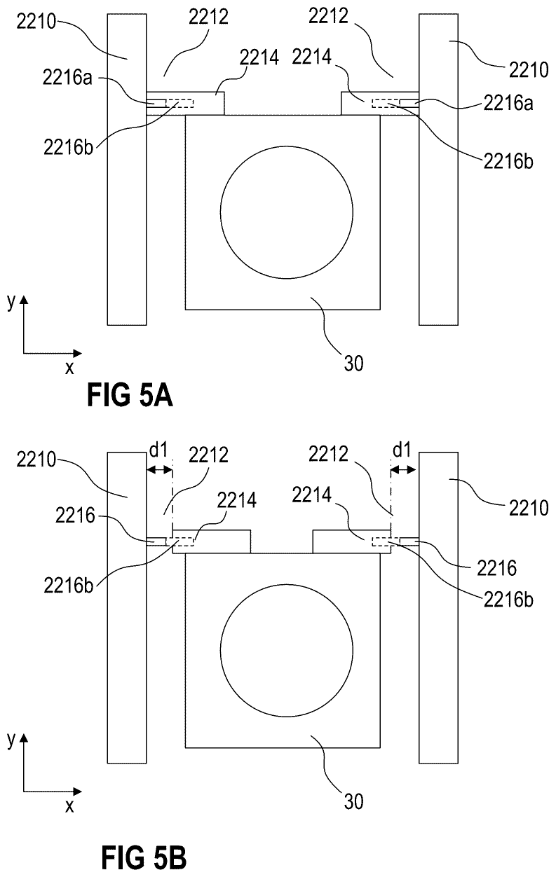

The low frequency speaker 30 may comprise a loudspeaker enclosure. The loudspeaker enclosure may be easily integrated in the chair 220 (e.g., the backrest 2202) and mounted to the frame 2210 of the chair 220 with the bearing 2212. The bearing 2212 may allow for a movement of the speaker 30 in a horizontal direction z, wherein the horizontal direction z is a direction parallel to a top surface of the seating area 2204. According to one example and as is schematically illustrated in FIG. 5, the bearing 2212 may comprise a first bearing member comprising a first bolt 2216 and a first rail 2214, and a second bearing member comprising a second bolt 2216 and a second rail 2214. The first rail 2214 may comprise a counterpart for the first bolt 2216, and the first bolt 2216 may be inserted into the counterpart. The first bolt 2216, in the example illustrated in FIG. 5, comprises a rigid first section 2216a, and a flexible second section 2216b. The rigid first section 2216a may comprise or consist of a metal or any other rigid material, for example, that cannot easily deform or vibrate. The flexible second section 2216b may comprise or consist of rubber, for example, or any other comparably flexible material that is strong enough to hold the low frequency speaker 30 in a desired position, while being flexible enough to budge and vibrate to a certain degree when the low frequency speaker 30 vibrates.

In the first state, the rigid first section 2216a is inserted into the counterpart such that the first rail 2214 is rigidly attached to or may pivot about the first bolt 2216 (FIG. 5A), and, in the second state, only the flexible second section 2216b is inserted into the counterpart (FIG. 5B), while the rigid first section 2216a is entirely arranged outside of the counterpart. The rigid first section 2216a of the bolt 2216 may be attached to the frame 2210, and the flexible second section 2216b may be attached to the rigid first section 2216a such that the rigid first section 2216a is arranged between the flexible second section 2216b and the frame 2210. In this way, when the rigid first section 2216a is inserted into the counterpart provided by the first rail 2214 (first state), vibrations are transmitted from the low frequency speaker 30 via the first rail 2214 to the rigid first section 2216a and from there to the frame 2210. When, in the second state, only the flexible second section 2216b is inserted into the counterpart provided by the first rail 2214, but not the rigid first section 2216a, vibrations are transmitted from the low frequency speaker 30 via the first rail 2214 to the flexible second section 2216b. The flexible second section 2216b, however, will itself start to vibrate and no, or only few vibrations will be transmitted from the flexible second section 2216b to the rigid first section 2216a.

The first rail 2214 may be movably attached to an enclosure of the low frequency speaker 30. In particular, the first rail 2214 may be moved from a first position to a second position and vice versa. In the first position, the first rail 2214 is arranged closer to the frame 2210 such that the rigid first section 2216a of the bolt 2216 is inserted into the counterpart provided by the first rail 2216. As is illustrated in FIG. 5A, in the first state, the flexible second section 2216b may be inserted into the counterpart as well. Due to the direct connection between the first rail 2214 and the rigid first section 2216a, however, vibrations are transmitted to the frame 2210, as described above. In the second position, a distance dl between the first rail 2214 and the frame 2210 is increased such that only the flexible second section 2216b, but not the rigid first section 2216a is inserted into the counterpart provided by the first rail 2214. The first rail 2214 can be moved from the first position to the second position and vice versa by any suitable mechanism.

The first bolt 2216 may generally have a round shape, for example, with a first diameter, and the first counterpart may be a sleeve or recess also having a round shape. A diameter of the sleeve or recess may be equal to or may be slightly larger than the first diameter of the first bolt 2216. Slightly larger in this context refers to a difference of between 0 and 0.5 mm (millimeters), for example. What is described with respect to the first rail 2214 and the first bolt 2216 similarly applies for the second rail 2214 and the second bolt 2216.

The first rail 2214 may be attached to the loudspeaker enclosure and extend from the loudspeaker enclosure towards a first side (e.g., right side), and the second rail 2214 may be attached to the loudspeaker enclosure and extend from the loudspeaker enclosure towards a second side, opposite the first side (e.g., left side). The first and second rail 2214 may be attached to an upper side of the loudspeaker enclosure, wherein the upper side is a side facing towards an upper end of the backrest 2202 opposite the lower end of the backrest 2202 and towards a headrest of the chair 220. In other words, when the speaker 30 is mounted to the chair 220 and the chair 220 is arranged in a vehicle 10, the speaker 30 may be arranged between the first and second rails 2214 and a road the vehicle 10 is travelling on.

The loudspeaker enclosure may comprise an opening, wherein the loudspeaker is mounted in the opening such that a first side of the sound radiating surface faces the inside of the enclosure, and a second side of the sound radiating surface faces towards the outside of the enclosure and towards the rear of the vehicle 10. The low frequency speaker 30 may be arranged centrally in the chair 220 in a horizontal direction x, wherein the horizontal direction x is a direction perpendicular to the horizontal direction z and parallel to a top surface of the seating area 2204, wherein a top surface of the seating area 2204 is a surface on which a user may be seated. In other words, a distance between the low frequency speaker 30 and a right side of the chair 220 may equal a distance between the low frequency speaker 30 and a left side of the chair 220. In this way, vibrations may be transferred from the low frequency speaker 30 to the frame 2210 in a symmetrical way which is perceived as very pleasant by occupant user seated on the chair 220.

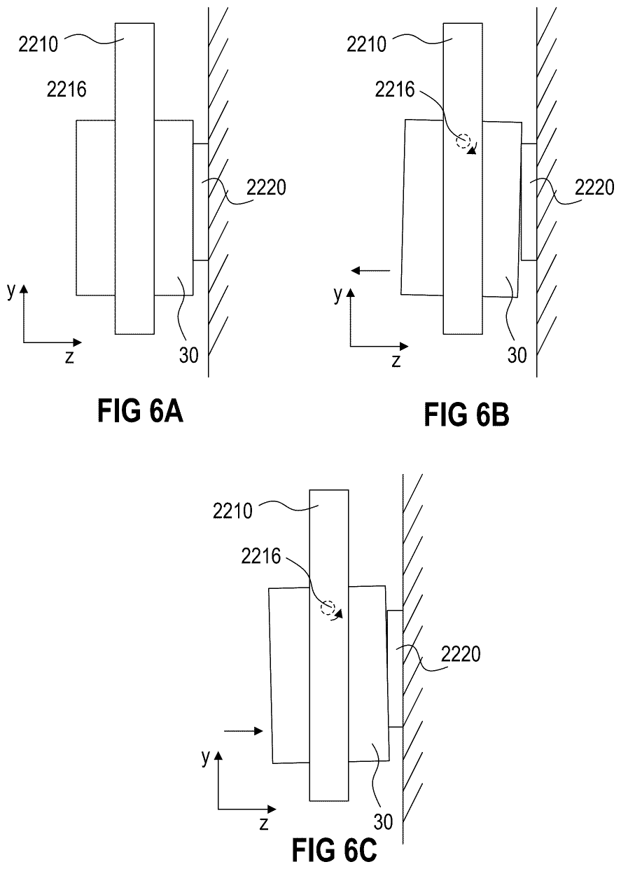

As has been described above, at least a backside of the low frequency speaker 30 may directly or indirectly adjoin the upholstery of the chair 220. According to one example, a contact layer 2220 is arranged between the backside of the low frequency speaker 30 and the upholstery. In the first state, this contact layer 2220 directly adjoins the low frequency speaker 30 as well as the upholstery such that, when the low frequency speaker 30 vibrates, the contact layer 2220 transmits the vibrations from the low frequency speaker 30 to the upholstery. A contact layer 2220 is schematically illustrated in FIGS. 4 and 6, for example. The contact layer 2220 may consist of a material that is different from the material of the upholstery, for example. In this way, the second acoustical path may be tuned and structure-borne sound may be transmitted to the upholstery in a balanced and controlled way. Such a contact layer 2220 may be glued to a surface of the upholstery facing towards the low frequency speaker 30, for example. The contact layer 2220, however, can also be held in its desired position between the low frequency speaker 30 and the upholstery in any other suitable way. In the first state, for example, the contact layer 2220 may be arranged between the low frequency speaker 30 and the upholstery in order to bridge a gap between the low frequency speaker 30 and the upholstery. The contact layer 2220 and the upholstery may be soft such that the low frequency speaker 30, as the low frequency speaker 30 vibrates, may be pressed into the contact layer 2220 (low frequency speaker 30 indirectly adjoins upholstery) or into the upholstery (low frequency speaker 30 directly adjoins upholstery) to a certain degree. This is schematically illustrated in FIGS. 6A, 6B, and 6C, for example, wherein FIG. 6A illustrates the low frequency speaker 30 in a resting position (no vibrations), and FIGS. 6B and 6C schematically illustrate the low frequency speaker 30 as the low frequency speaker 30 vibrates back and forth (slightly pivoting about the bolts 2216). In FIGS. 6A, 6B and 6C, the upholstery is indicated hatched (right side of figures). A slight pivoting movement of the rail 2214 about the bolt 2216 is indicated by an arrow. Similarly, the movement of the low frequency speaker 30 (vibrations) is indicated by an arrow.

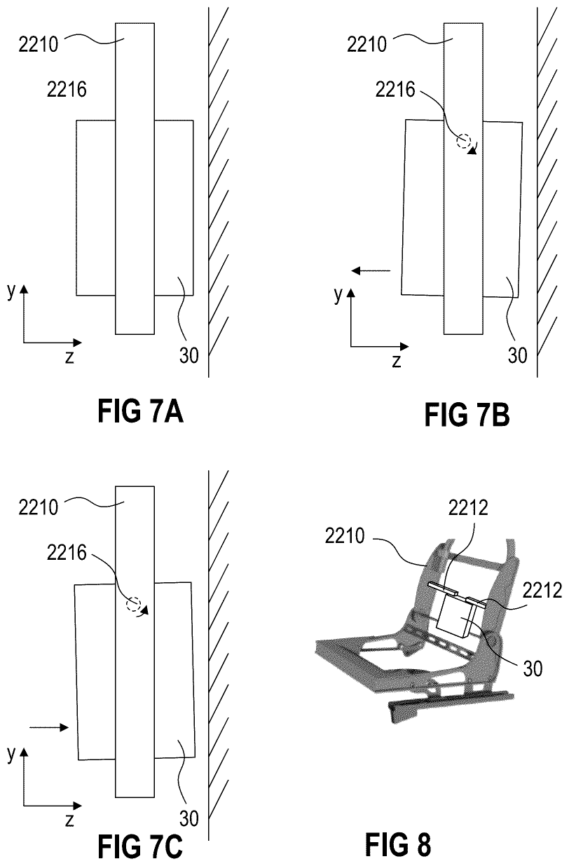

In the second state, the contact layer 2220 may be moved to a second position such that it is no longer arranged between the low frequency speaker 30 and the upholstery. This is schematically illustrated in FIGS. 7A, 7B and 7C. As can be seen, when the contact layer 2220 is moved to a second position and is no longer arranged between the low frequency speaker 30 and the upholstery, vibrations are not transferred from the low frequency speaker 30 to the upholstery, and the second acoustical path is interrupted. Removing the contact layer 2220 in order to interrupt the second acoustical path, however, is only one example. According to another example, the low frequency speaker 30, in the second state, is moved (e.g., in a direction away from the upholstery towards the back of the chair 220) in order to increase a distance between the low frequency speaker 30 and the contact layer 2220. The increased distance may be large enough such that the low frequency speaker 30 no longer adjoins the contact layer 2220, even when it vibrates. In this way, the second acoustical path can also be interrupted. The second acoustical path can generally be interrupted in any other suitable way.

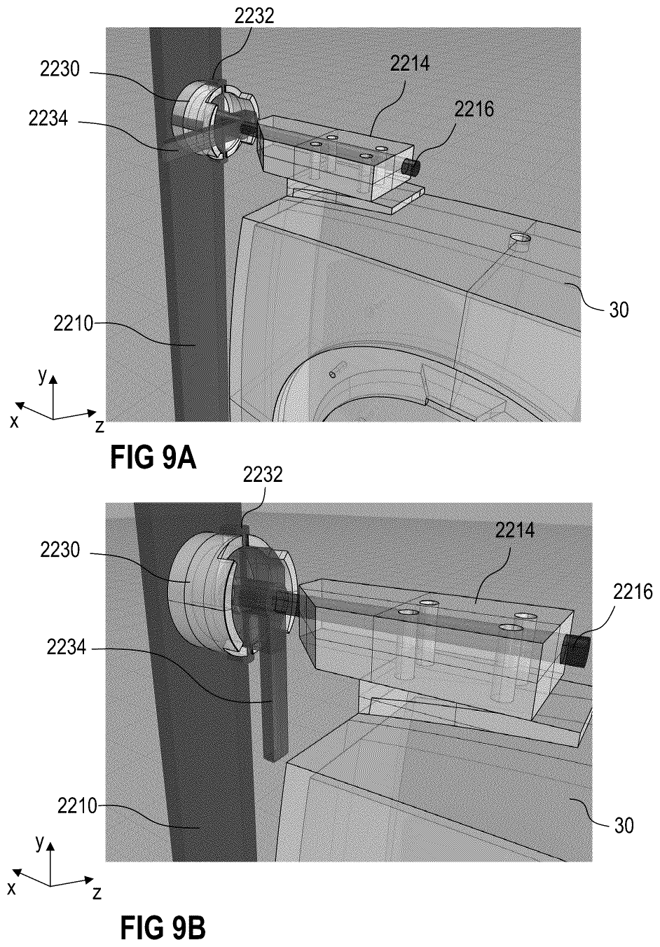

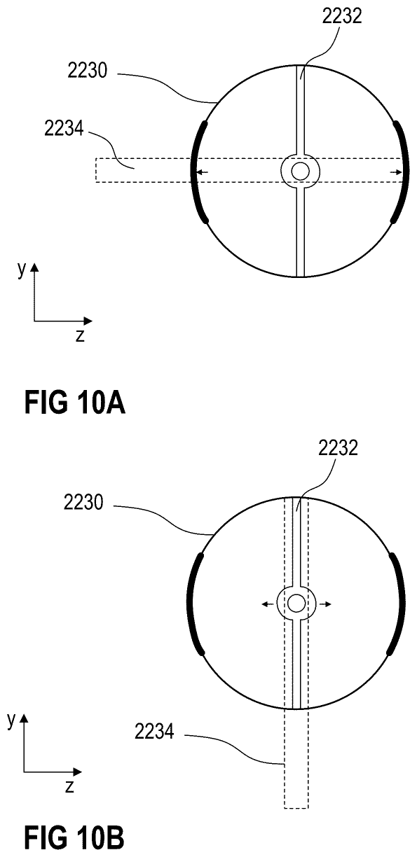

Now referring to FIGS. 9A, 9B, 10A and 10B, a bearing according to further embodiments of the disclosure is schematically illustrated. The bearing in this example, in addition to the rail 2214 and the bolt 2216, further comprises a mounting mechanism. The bolt 2216 in this example does not comprise a flexible section. That is, the bolt 2216 is a rigid component and is inserted in the counterpart provided by the rail 2214. The bolt 2216 may be firmly attached (rigidly connected) to the rail 2214 or may be pivotably attached to the rail 2214. The bolt 2216, instead of being firmly attached to the frame 2210, as described with respect to FIG. 5 above, is attached to the frame 2210 by the mounting mechanism. The mounting mechanism comprises a rigid component 2230 that is firmly attached to the frame 2210, and a flexible component 2232 coupled to the rigid component 2230. The bolt 2216 is attached to the flexible component 2232. For example, the flexible component 2232 may comprise a second counterpart and the bolt 2216 may be inserted into the counterpart provided by the rail 2214 with a first end, and into the second counterpart provided by the flexible component 2232 with a second end, opposite the first end. The mounting mechanism further comprises a lever 2234. The lever 2234 is attached to the bolt 2216 at a position between the rail 2214 and the flexible component 2232. For example, the lever 2234 may comprise a through hole, and the bolt 2216 may extend through the through hole. The lever 2234 is configured to be moved from a first position to a second position and vice versa. When the lever 2234 is in the first position, a firm connection is formed between the bolt 2216 and the rigid component 2230 (see FIGS. 9A and 10A), and, when the lever 2234 is in the second position, the bolt 2216 is only directly coupled to the flexible component 2232, but there is no firm connection between the bolt 2216 and the rigid component 2230.

That is, when the lever 2234 is in the first position, vibrations caused by the low frequency speaker 30 are transmitted via the rail 2214, the bolt 2216, the lever 2234, and the rigid component 2230 to the frame 2210. When the lever 2234 is in the second position, vibrations caused by the low frequency speaker 30 are transmitted via the rail 2214 and the bolt 2216 to the flexible component 2232. The flexible component 2232 will itself start to vibrate and no, or only few or (significantly) damped vibrations will be transmitted from the flexible component 2232 to the rigid component 2230 and the frame 2210.

The rigid component 2230 may be or may, for example, comprise a sleeve. The sleeve may be partly interrupted along a circumference thereof. When the lever 2234 is in the first position, the level 2234 may contact and directly adjoin the sleeve such that, when the low frequency speaker 30 vibrates, the vibrations are transmitted from the bolt 2216 via the lever 2234 to the sleeve. When the lever 2234 is in the second position, the level 2234 may be arranged such that the level 2234 faces towards areas in which the sleeve is interrupted. That is, in the second position, the lever 2234 does not directly adjoin the sleeve and vibrations are not transmitted from the lever 2234 to the sleeve. The lever 2234 arranged in the first position is schematically illustrated in FIGS. 9A and 10A. Portions of the sleeve that are not interrupted are schematically illustrated as bold sections in FIG. 10A. Vibrations transmitted from the lever 2234 to the rigid component 2230 are indicated by arrows in FIG. 10A. The lever 2234 is illustrated in dashed lines in FIG. 10A in order to not conceal any of the other components. The lever 2234 arranged in the second position is schematically illustrated in FIGS. 9B and 10B. As discussed above, vibrations are not transmitted from the lever 2234 to the rigid component 2230 in the second state. Instead, the flexible component 2232 vibrates, which is indicated by arrows in FIG. 10B. The flexible component 2232 may comprise rubber, for example, or any other comparably flexible material that is stable enough to hold the bolt 2216 in a desired position, while being flexible enough to budge and vibrate to a certain degree when the low frequency speaker 30 vibrates. Summarizing the above, the flexible component 2232 flexibly connects the bolt 2216 to the rigid component 2230. The lever 2234 can be considered as being inactive when in its second position. In the first position, the lever 2234 provides a mechanical connection (mechanical shortcut) between the bolt 2216 and the rigid component 2230. That is, when the lever 2234 is in its first state, the flexible component 2232 can be considered as being inactive.

In one example, the chair 220 may be a driver's seat of the vehicle 10. Similar to what has been described above, a second low frequency speaker 32 may be arranged in a front passenger seat 222. That is, a front passenger seat 222 may comprise a seating area 2204 and a backrest 2202, wherein the seating area 2204 is arranged at a lower end of the backrest 2202, a low frequency speaker 32 configured to emit sound at frequencies of between 20 Hz and 200 Hz, and a coupling mechanism 40 that is configured to change between at least two different states, wherein, in a first state, the low frequency speaker 32 is coupled to the front passenger seat 222 via at least one acoustical path such that vibrations are transmitted from the low frequency speaker 32 to the front passenger seat 222 via each of the at least one acoustical path, wherein the vibrations can be perceived as tactile feedback by an occupant seated on the front passenger seat 222, and, in a second state, each of the at least one acoustical path is interrupted such that no or almost no vibrations are transmitted from the low frequency speaker 32 to the front passenger seat 222 that cannot be perceived as tactile feedback by an occupant seated on the front passenger seat 222.

The one or more low frequency speakers 30, 32 as described above may be easily integrated into an existing soundstage arranged in front of the driver and/or front passenger of a vehicle 10. For a driver/front passenger 24 of a vehicle 10, the arrangement of the loudspeakers as has been described above may generate the feeling that the driver/front passenger is surrounded by the bass generated by the low frequency speakers 30, 32.

It may be understood, that the illustrated systems are merely examples. While various embodiments of the invention have been described, it will be apparent to those of ordinary skill in the art that many more embodiments and implementations are possible within the scope of the invention. In particular, the skilled person will recognize the interchangeability of various features from different embodiments. Although these techniques and systems have been disclosed in the context of certain embodiments and examples, it will be understood that these techniques and systems may be extended beyond the specifically disclosed embodiments to other embodiments and/or uses and obvious modifications thereof. Accordingly, the invention is not to be restricted except in light of the attached claims and their equivalents.

The description of embodiments has been presented for purposes of illustration and description. Suitable modifications and variations to the embodiments may be performed in light of the above description or may be acquired from practicing the methods. The described arrangements are exemplary in nature and may include additional elements and/or omit elements. As used in this application, an element recited in the singular and proceeded with the word “a” or “an” should be understood as not excluding plural of said elements, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The described systems are exemplary in nature and may include additional elements and/or omit elements. The subject matter of the present disclosure includes all novel and non-obvious combinations and sub-combinations of the various systems and configurations, and other features, functions, and/or properties disclosed. The following claims particularly point out subject matter from the above disclosure that is regarded as novel and non-obvious.

What is claimed is:

1. A chair comprising:
a seating area and a backrest, wherein the seating area is arranged at a lower end of the backrest;
a low frequency speaker configured to emit sound at frequencies of between 20 Hz and 200 Hz; and
a coupling mechanism configured to change between at least two different states, wherein, in a first state, the low frequency speaker is coupled to the chair via at least one acoustical path such that vibrations are transmitted from the low frequency speaker to the chair via each of the at least one acoustical path, wherein the vibrations can be perceived as tactile feedback by a user seated on the chair, and, in a second state, each of the at least one acoustical path is interrupted such that no or almost no vibrations are transmitted from the low frequency speaker to the chair that cannot be perceived as tactile feedback by a user seated on the chair.

2. The chair of claim 1 further comprising a frame covered by upholstery, wherein the frame and upholstery define the seating area and the backrest, and the coupling mechanism comprises a contact layer, wherein,
in the first state, the contact layer is arranged between a backside of the low frequency speaker and the upholstery and directly adjoins the low frequency speaker and the upholstery, wherein the backside of the low frequency speaker is a side which faces towards an inside of the chair and,
in the second state, direct contact between the contact layer and at least one of the low frequency speaker and the upholstery is interrupted.

3. The chair of claim 1 further comprising a frame covered by upholstery, wherein the frame and upholstery define the seating area and the backrest, and the coupling mechanism comprises a bearing mounting the low frequency speaker to the frame.

4. The chair of claim 3, wherein the bearing comprises:
a first bearing member comprising a first bolt and a first rail, the first rail comprising a counterpart, and the first bolt comprising a rigid first section and a flexible second section, wherein, in the first state, the rigid first section is inserted into the counterpart such that the first rail is rigidly attached to or may pivot about the first bolt, and, in the second state, the flexible second section is inserted into the counterpart and the rigid first section is entirely arranged outside of the counterpart, and
a second bearing member comprising a second bolt and a second rail, the second rail comprising a counterpart, and the second bolt comprising a rigid first section and a flexible second section, wherein, in the first state, the rigid first section is inserted into the counterpart such that the second rail is rigidly attached to or may pivot about the second bolt, and, in the second state, the flexible second section is inserted into the counterpart and the rigid first section is entirely arranged outside of the counterpart.

5. The chair of claim 4, wherein
the low frequency speaker comprises a loudspeaker enclosure, and
the first rail is attached to the loudspeaker enclosure and extends from the loudspeaker enclosure towards a first side, and the second rail is attached to the loudspeaker enclosure and extends from the loudspeaker enclosure towards a second side, opposite the first side.

6. The chair of claim 5, wherein the first rail and the second rail are attached to an upper side of the loudspeaker enclosure, wherein the upper side is a side facing towards an upper end of the backrest opposite the lower end of the backrest.

7. The chair of claim 3, wherein the bearing comprises a first bearing member and a second bearing member, wherein each of the first and second bearing members comprises a bolt, a rail, and a mounting mechanism, and wherein
the rail comprises a first counterpart, and a first end of the bolt is inserted into the counterpart such that the rail is rigidly attached to or may pivot about the bolt,
the mounting mechanism comprises a rigid component that is firmly attached to the frame, and a flexible component coupled to the rigid component,
a second end of the bolt, opposite the first end, is attached to the flexible component,
the mounting mechanism further comprises a lever attached to the bolt at a position between the rail and the flexible component, wherein the lever is configured to be moved from a first position to a second position and vice versa, wherein, when the lever is in the first position, a firm connection is formed between the bolt and the rigid component, and, when the lever is in the second position, the bolt is only directly coupled to the flexible component, without a firm connection between the bolt and the rigid component.

8. The chair of claim 7, wherein the flexible component comprises rubber.

9. The chair of claim 7, wherein the rigid component is or comprises a sleeve, wherein the sleeve is partly interrupted along its circumference such that, when the lever is in the first position, the lever contacts and directly adjoins the sleeve, and, when the lever is in the second position, the lever faces towards areas in which the sleeve is interrupted such that contact between the lever and the rigid component is interrupted.

10. The chair of claim 1, wherein the chair is a car seat arranged in a vehicle.

11. A chair comprising:
a seating area and a backrest, wherein the seating area is arranged at a lower end of the backrest;
a low frequency speaker configured to emit sound at frequencies of between 20 Hz and 200 Hz; and
a coupling mechanism configured to change between at least two different states, wherein, in a first state, the low frequency speaker is coupled to the chair via at least one acoustical path such that vibrations are transmitted from the low frequency speaker to the chair via each of the at least one acoustical path, wherein the vibrations can be perceived as tactile feedback by a user seated on the chair, and, in a second state, each of the at least one acoustical path is interrupted such that no or almost no vibrations are transmitted from the low frequency speaker to the chair.

12. The chair of claim 11 further comprising a frame covered by upholstery, wherein the frame and upholstery define the seating area and the backrest, and the coupling mechanism comprises a contact layer, wherein,
in the first state, the contact layer is arranged between a backside of the low frequency speaker and the upholstery and directly adjoins the low frequency speaker and the upholstery, wherein the backside of the low frequency speaker is a side which faces towards an inside of the chair and,
in the second state, direct contact between the contact layer and at least one of the low frequency speaker and the upholstery is interrupted.

13. The chair of claim 1 further comprising a frame covered by upholstery, wherein the frame and upholstery define the seating area and the backrest, and the coupling mechanism comprises a bearing mounting the low frequency speaker to the frame.

14. The chair of claim 13, wherein the bearing comprises:
a first bearing member comprising a first bolt and a first rail, the first rail comprising a counterpart, and the first bolt comprising a rigid first section and a flexible second section, wherein, in the first state, the rigid first section is inserted into the counterpart such that the first rail is rigidly attached to or may pivot about the first bolt, and, in the second state, the flexible second section is inserted into the counterpart and the rigid first section is entirely arranged outside of the counterpart, and
a second bearing member comprising a second bolt and a second rail, the second rail comprising a counterpart, and the second bolt comprising a rigid first section and a flexible second section, wherein, in the first state, the rigid first section is inserted into the counterpart such that the second rail is rigidly attached to or may pivot about the second bolt, and, in the second state, the flexible second section is inserted into the counterpart and the rigid first section is entirely arranged outside of the counterpart.

15. The chair of claim 14, wherein
the low frequency speaker comprises a loudspeaker enclosure, and
the first rail is attached to the loudspeaker enclosure and extends from the loudspeaker enclosure towards a first side, and the second rail is attached to the loudspeaker enclosure and extends from the loudspeaker enclosure towards a second side, opposite the first side.

16. A chair comprising:
a seating area and a backrest, wherein the seating area is arranged at a lower end of the backrest;
a low frequency speaker configured to emit sound at frequencies of between 20 Hz and 200 Hz; and
a coupling mechanism configured to change between a first state in which the low frequency speaker is coupled to the chair via at least one acoustical path such that vibrations are transmitted from the low frequency speaker to the chair via each of the at least one acoustical path, wherein the vibrations can be perceived as tactile feedback by a user seated on the chair, and, in a second state, each of the at least one acoustical path is interrupted such that no or almost no vibrations are transmitted from the low frequency speaker to the chair that cannot be perceived as tactile feedback by a user seated on the chair.

17. The chair of claim 16 further comprising a frame covered by upholstery, wherein the frame and upholstery define the seating area and the backrest, and the coupling mechanism comprises a contact layer, wherein,
in the first state, the contact layer is arranged between a backside of the low frequency speaker and the upholstery and directly adjoins the low frequency speaker and the upholstery, wherein the backside of the low frequency speaker is a side which faces towards an inside of the chair and,
in the second state, direct contact between the contact layer and at least one of the low frequency speaker and the upholstery is interrupted.

18. The chair of claim 16 further comprising a frame covered by upholstery, wherein the frame and upholstery define the seating area and the backrest, and the coupling mechanism comprises a bearing mounting the low frequency speaker to the frame.

19. The chair of claim 18, wherein the bearing comprises:
a first bearing member comprising a first bolt and a first rail, the first rail comprising a counterpart, and the first bolt comprising a rigid first section and a flexible second section, wherein, in the first state, the rigid first section is inserted into the counterpart such that the first rail is rigidly attached to or may pivot about the first bolt, and, in the second state, the flexible second section is inserted into the counterpart and the rigid first section is entirely arranged outside of the counterpart, and
a second bearing member comprising a second bolt and a second rail, the second rail comprising a counterpart, and the second bolt comprising a rigid first section and a flexible second section, wherein, in the first state, the rigid first section is inserted into the counterpart such that the second rail is rigidly attached to or may pivot about the second bolt, and, in the second state, the flexible second section is inserted into the counterpart and the rigid first section is entirely arranged outside of the counterpart.

20. The chair of claim 19, wherein
the low frequency speaker comprises a loudspeaker enclosure, and
the first rail is attached to the loudspeaker enclosure and extends from the loudspeaker enclosure towards a first side, and the second rail is attached to the loudspeaker enclosure and extends from the loudspeaker enclosure towards a second side, opposite the first side.
